(19) United States
(12) Patent Application Publication
(10) Pub. No.: US 2025/0020157 A1
(43) Pub. Date: Jan. 16, 2025

(54) STABLY-CONNECTED EMBEDDED BOLT

(71) Applicant: Hebei Qinhuai Data Co., Limited., Zhangjiakou City (CN)

(72) Inventor: Binghua ZHANG, Zhangjiakou City (CN)

(21) Appl. No.: 18/764,311

(22) Filed: Jul. 4, 2024

(30) Foreign Application Priority Data
Jul. 12, 2023 (CN) 202310855691.2

(51) Int. Cl. F16B 39/10

(52) U.S. Cl. CPC F16B 39/10

(57) ABSTRACT

The present disclosure discloses a stably-connected embedded bolt, including a mounting plate. A bolt is slidably connected to interior of the mounting plate, a limit plate is fixedly connected to the bolt, and the limit plate comes into contact with the mounting plate. A slide block is slidably connected to interior of the limit plate, a slide rod is fixedly connected to the slide block, the slide rod is slidably connected to interior of the limit plate, and a spring is arranged on the limit plate.

### CROSSREFERENCE TO RELATED APPLICATION

This application claims priority to Chinese Patent Application No. 202310855691.2, titled “STABLY-CONNECTED EMBEDDED BOLT” and filed to the China National Intellectual Property Administration on Jul. 12, 2023, the entire contents of which are incorporated herein by reference.

### TECHNICAL FIELD

The present disclosure relates to the field of embedded bolt technology, and more particularly, to a stably-connected embedded bolt.

### BACKGROUND

Serving as a mechanical component, a bolt is a cylindrical threaded fastener fitting with a nut. As a fastener comprising a head and a threaded rod (a cylindrical body with external threads), the bolt needs to fit with the nut to tighten and connect two components with through holes. This type of connection is referred to as a bolt connection. After the nut is unscrewed from the bolt, the two components may be separated from each other, so the bolt connection is a detachable connection. An embedded bolt is also referred to as an anchor bolt. The embedded bolt refers to a steel part that is fixed with cement in advance to secure equipment during equipment installation. However, when the embedded bolt is connected to a mounting plate, if it is only limited by the nut, unstable connection between the embedded bolt and the mounting plate may be caused if the nut becomes loose after installation.

### SUMMARY

The present disclosure provides a stably-connected embedded bolt, aiming to solve a problem that unstable connection between the embedded bolt and a mounting plate may be caused if a nut becomes loose after installation when the embedded bolt is connected to the mounting plate only by means of the nut.

According to embodiments of the present disclosure, a stably-connected embedded bolt is provided, which includes a mounting plate. A bolt is slidably connected to interior of the mounting plate, a limit plate is fixedly connected to the bolt, and the limit plate comes into contact with the mounting plate. A slide block is slidably connected to interior of the limit plate, and a slide rod is fixedly connected to the slide block, where the slide rod is slidably connected to interior of the limit plate, and a spring is arranged on the limit plate. A fixture block is fixedly connected to the slide block, a fixture groove is provided on the mounting plate, a nut is connected to an outer side of the bolt through a screw thread, and the nut comes into contact with the mounting plate. The outer side of the bolt is slidably sleeved with a limit sleeve, where the limit sleeve comes into contact with the mounting plate. A limit block is fixedly connected to the limit sleeve, and the limit block is clamped to interior of the mounting plate.

In the stably-connected embedded bolt of the present disclosure, one end of the spring comes into contact with the limit plate, and other end of the spring comes into contact with the slide rod. Through the design of the spring, the fixture block can be driven to limit the limit plate.

In the stably-connected embedded bolt of the present disclosure, the fixture block is slidably connected to interior of the fixture groove, and the fixture block comes into contact with the limit plate. Through the design of the fixture block, the limit plate can be limited.

In the stably-connected embedded bolt of the present disclosure, number of the limit sleeves is two, and the two limit sleeves are symmetrically distributed on the mounting plate. Through the design of the limit sleeves, the nut can be limited.

In the stably-connected embedded bolt of the present disclosure, a limit groove is provided on the limit sleeve, and the limit groove is slidably sleeved on the nut. Through the design of the limit groove, the nut can be limited by the limit sleeve.

In the stably-connected embedded bolt of the present disclosure, two limit blocks are provided on each of the limit sleeves, and the two limit blocks are symmetrically distributed on the limit sleeve. Through the design of the limit blocks, the limit sleeve can be limited.

The technical solutions provided by the embodiments of the present disclosure may include following beneficial effects.

The present disclosure designs a stably-connected embedded bolt. By arranging components such as the limit plate, the slide block, a fixture block, and a fixture groove, the spring can drive the fixture block to fix to the mounting plate, such that the fixture block can limit the bolt and thus the bolt does not shift, thereby preventing a nut from becoming loose due to shake of the bolt. In this way, it is solved a problem that unstable connection between the embedded bolt and the mounting plate may be caused if the nut becomes loose after installation when the embedded bolt is connected to the mounting plate only by means of the nut.

The present disclosure designs a stably-connected embedded bolt. By arranging components such as the limit sleeve and the limit groove, the nut can be limited by the limit sleeve, ensuring that the nut remains stable after installation. Furthermore, by arranging the limit block, the limit sleeve can be limited by the limit block, such that the limit sleeve can remain stable when the nut is limited by the limit sleeve.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a three-dimensional view of an overall structure according to the present disclosure;

FIG. 2 is an elevation cross-sectional view of FIG. 1; and

FIG. 3 is an enlarged view of a structure of Part A in FIG. 2.

Reference numerals in the accompanying drawings:
mounting plate 1; bolt 2; limit plate 3; slide block 31; slide rod 32; spring 33; fixture block 34; fixture groove 35; nut 4; limit sleeve 41; limit groove 42; and limit block 43.

### DETAILED DESCRIPTION

Technical solutions in the embodiments of the present disclosure will be described clearly and completely below, in conjunction with the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should also be understood that the terms used in this specification of the present disclosure are only for the purpose of describing particular embodiments and are not intended to limit the present disclosure. As used in the specification and the appended claims of the present disclosure, the singular forms of “a”, “an” and “the” may be intended to include the plural forms, unless the context clearly indicates otherwise.

It should also be further understood that the term “and/or” used in the specification and the appended claims of the present disclosure refers to any combination of one or more of the relevantly listed items and all possible combinations, and includes these combinations.

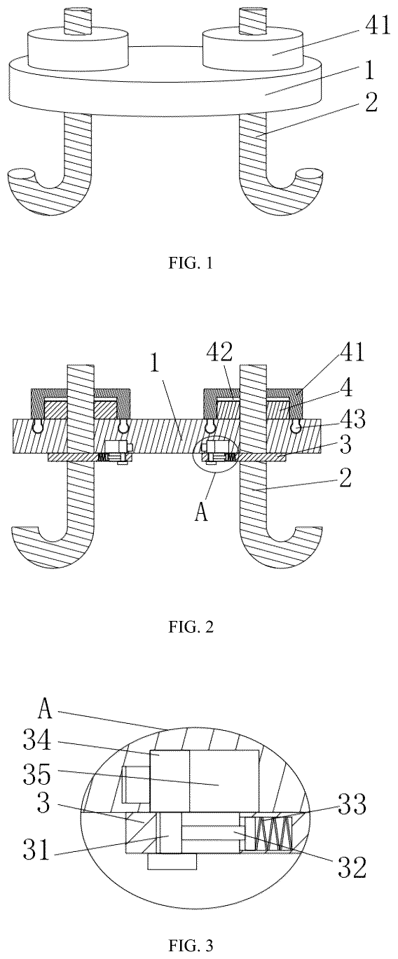

Referring to FIGS. 1 to 3, the present disclosure discloses a stably-connected embedded bolt, including a mounting plate 1. A bolt 2 is slidably connected to interior of the mounting plate 1, a limit plate 3 is fixedly connected to the bolt 2, and the limit plate 3 comes into contact with the mounting plate 1. A slide block 31 is slidably connected to interior of the limit plate 3, a slide rod 32 is fixedly connected to the slide block 31, and the slide rod 32 is slidably connected to interior of the limit plate 3. A spring 33 is arranged on the limit plate 3, where one end of the spring 33 comes into contact with the limit plate 3, and other end of the spring 33 comes into contact with the slide rod 32. Through the design of the spring 33, the fixture block 34 can be driven to limit the limit plate 3.

Referring to FIGS. 2 to 3, the fixture block 34 is fixedly connected to the slide block 31, a fixture groove 35 is provided on the mounting plate 1, the fixture block 34 is slidably connected to interior of the fixture groove 35, and the fixture block 34 comes into contact with the limit plate 3. Through the design of the fixture block 34, the limit plate 3 can be limited. A nut 4 is connected to an outer side of the bolt 2 through a screw thread, and the nut 4 comes into contact with the mounting plate 1. The outer side of the bolt 2 is slidably sleeved with a limit sleeve 41. Number of the limit sleeves 41 is two, and the two limit sleeves 41 are symmetrically distributed on the mounting plate 1. Through the design of the limit sleeves 41, the nut 4 can be limited.

Referring to FIGS. 2 to 3, the limit sleeve 41 comes into contact with the mounting plate 1, a limit groove 42 is provided on the limit sleeve 41, and the limit groove 42 is slidably sleeved on the nut 4. Through the design of the limit groove 42, the nut 4 can be limited by the limit sleeve 42. A limit block 43 is fixedly connected to the limit sleeve 41. Two limit blocks 43 are provided on each of the limit sleeves 41, and the two limit blocks 43 are symmetrically distributed on the limit sleeve 41. Through the design of the limit blocks 43, the limit sleeve 41 can be limited. The limit blocks 43 are clamped to interior of the mounting plate 1.

Specific implementation processes of the present disclosure are as follows. When in use, by moving the slide block 31 to a direction close to the bolt 2, the slide block 31 slides inside the limit plate 3, such that the slide block 31 drives the slide rod 32 to slide inside the limit plate 3, the slide rod 32 squeezes the spring 33, and the slide block 31 drives the fixture block 34 to move. Next, the bolt 2 is assembled with the mounting plate 1, such that the limit plate 3 on the bolt 2 comes into contact with the mounting plate 1, and the fixture block 34 slides into the fixture groove 35 on the mounting plate 1. Next, the slide block 31 is released, and an elastic force from the spring 33 drives the slide rod 32 to move, causing the slide rod 32 to drive the slide block 31 to move, which causes the slide block 31 to drive the fixture block 34 to slide inside the fixture groove 35, such that the fixture block 34 is clamped to the mounting plate 1 to limit the bolt 2 on the mounting plate 1. Next, the nut 4 is assembled with the bolt 2, such that the nut 4 comes into contact with the mounting plate 1, to limit the nut 4 and the bolt 2. Next, the limit sleeve 41 is sleeved on the nut 4, such that the nut 4 slides into the limit groove 42 on the limit sleeve 41, which allows the limit sleeve 41 to limit the nut 4. Simultaneously, the limit block 43 on the limit sleeve 41 is clipped into the mounting plate 1 to ensure that the limit sleeve 41 remains stable when limiting the nut 4.

The preceding descriptions are merely specific embodiments of the present disclosure, but the protection scope of the present disclosure is not limited thereto. Any equivalent modifications or replacements easily conceivable to a person of skilled in the art within the technical scope disclosed in the present disclosure shall fall within the protection scope of the present disclosure. Therefore, the protection scope of the present disclosure shall be subject to that of the claims.

What is claimed is:

1. A stably-connected embedded bolt, comprising a mounting plate, wherein a bolt is slidably connected to interior of the mounting plate, a limit plate is fixedly connected to the bolt, the limit plate comes into contact with the mounting plate, a slide block is slidably connected to interior of the limit plate, a slide rod is fixedly connected to the slide block, the slide rod is slidably connected to interior of the limit plate, a spring is arranged on the limit plate, a fixture block is fixedly connected to the slide block, a fixture groove is provided on the mounting plate, a nut is connected to an outer side of the bolt through a screw thread, the nut comes into contact with the mounting plate, the outer side of the bolt is slidably sleeved with a limit sleeve, the limit sleeve comes into contact with the mounting plate, a limit block is fixedly connected to the limit sleeve, and the limit block is clamped to interior of the mounting plate.

2. The stably-connected embedded bolt according to claim 1, wherein one end of the spring comes into contact with the limit plate, and other end of the spring comes into contact with the slide rod.

3. The stably-connected embedded bolt according to claim 1, wherein a fixture block is slidably connected to interior of the fixture groove, and the fixture block comes into contact with the limit plate.

4. The stably-connected embedded bolt according to claim 1, wherein number of the limit sleeves is two, and the two limit sleeves are symmetrically distributed on the mounting plate.

5. The stably-connected embedded bolt according to claim 1, wherein a limit groove is provided on the limit sleeve, and the limit groove is slidably sleeved on the nut.

6. The stably-connected embedded bolt according to claim 1, wherein two limit blocks are provided on each of the limit sleeves, and the two limit blocks are symmetrically distributed on the limit sleeve.
